(19) United States
(12) Patent Application Publication
(10) Pub. No.: US 2022/0267681 A1
(43) Pub. Date: Aug. 25, 2022

(54) FLUIDIZED CRACKING PROCESS FOR INCREASING OLEFIN YIELD AND CATALYST COMPOSITION FOR SAME

(71) Applicant: W. R. GRACE & CO.-CONN., Columbia, MD (US)

(72) Inventors: Udayshankar Singh, Ellicott City, MD (US); Ranjit Kumar, Columbia, MD (US); Michael Scott Ziebarth, Columbia, MD (US); Wu-Cheng Cheng, Ellicott City, MD (US)

(73) Assignee: W. R. GRACE & CO.-CONN., Columbia, MD (US)

(21) Appl. No.: 17/625,312

(22) PCT Filed: Jul. 6, 2020
(86) PCT No.: PCT/US2020/040885

§ 371 Date: Jan. 6, 2022

Related U.S. Application Data
(60) Provisional application No. 62/872,468, filed on Jul. 10, 2019.

(51) Int. Cl. C10G 11/18; C10G 11/05; B01J 35/02; B01J 23/745; B01J 27/16; B01J 29/46; B01J 29/08; B01J 29/90; B01J 38/02; B01J 38/06

(52) U.S. Cl. CPC C10G 11/182; C10G 11/05; B01J 35/023; B01J 23/745; B01J 27/16; C10G 2400/20; B01J 29/08; B01J 29/90; B01J 38/02; B01J 38/06; B01J 29/46

(57) ABSTRACT

An improved process and catalyst composition for cracking hydrocarbons in a fluidized cracking process are disclosed. The process employs circulating inventory of a regenerated cracking having a minimal carbon content. The regenerated catalyst comprises a catalyst/additive composition which contains a pentasil zeolite, iron oxide, and a phosphorous compound. In accordance with the present disclosure, the catalyst/additive contains controlled amounts of iron oxide which is maintained in an oxidized state by maintaining low amounts of carbon on the regenerated catalyst inventory. In this manner it was discovered that the catalyst composition greatly enhances the production and selectivity of light hydrocarbons, such as propylene.

### RELATED APPLICATIONS

The present application is based on and claims priority to U.S. Provisional Patent application Ser. No. 62/872,468, filed on Jul. 10, 2019, which is incorporated herein by reference.

### BACKGROUND

Fluid catalytic cracking (FCC) generally refers to a process in which high-boiling, high-molecular weight hydrocarbon compounds, contained in a hydrocarbon feedstock, such as a petroleum crude oil, are converted into more valuable products, such as gasoline, diesel, and light olefins. During the process, the hydrocarbon feedstock is fed into a fluidized reactor and combined with a catalyst at high temperatures that causes the high-molecular weight hydrocarbons to convert to lower molecular weight products.

A product stream produced from a fluid catalytic cracking process generally contains hydrocarbons in the greatest amounts. The amount of light olefins, such as propylene and ethylene, produced during the process can depend upon various factors. Recently, the demand for propylene as an important feedstock to manufacture a wide range of chemicals and polymers has dramatically increased. Despite significant investment in the production capacity of propylene, worldwide supply still lags behind demand for light olefins. For example, the use of polypropylene polymers remains one of the fastest growing synthetic materials for use in new and existing applications.

In view of the above, those skilled in the art have attempted to modify the fluid catalytic cracking process in order to improve light olefins yield, such as the yield of propylene. For example, U.S. Patent Publication No. 2009/0134065, which is incorporated herein by reference, describes a fluidized catalyst composition that increases olefin yields compared to other commercially available catalysts. The catalyst composition described in the '065 application have made great advances in the art in the production of light olefins, such as propylene.

Light olefins, such as propylene and ethylene, are an important feedstock used to manufacture a wide range of chemicals and products, including various different polymers. Despite significant investment in the production capacity of light olefins, the supply of light olefins has not kept up with demand. Consequently, there remains a need for further improvements in the design of FCC processes and catalyst and/or additive compositions to provide hydrocarbon products having increased light olefins yield and selectivity.

### SUMMARY

The present disclosure is directed to an improved process for producing light olefins products in a fluid catalytic cracking process in which the process increases the yields of light olefins, i.e. from C2- to C4-olefins, as compared to prior commercially available FCC process. Advantageously, the process also increases the selectivity for C2- and C3-olefins. The present invention is also directed to an improved FCC catalyst and/or additive composition, and the use thereof in a FCC process to increase light olefins yield and selectivity of C2- and C3-olefins over C4-olefins.

Accordingly, the present invention is directed to an inventive FCC process, wherein the process comprises;
(a) introducing a hydrocarbon feedstock into a reaction zone of a fluid catalytic cracking unit (“FCCU”) comprised of a reactor (also known as a “riser”), a stripper, and a regenerator, in which feedstock is characterized as having an initial boiling point from about 30° C. with end points up to about 850° C.;
(b) catalytically cracking said feedstock in said riser at a temperature from about 400° C. to about 700° C., by contacting the feedstock with a circulating inventory of a regenerated catalyst comprising a pentasil containing catalyst/additive composition which comprises:
   (i) pentasil zeolite having a silica/alumina framework,
   (ii) at least 5.0% by weight phosphorus (P₂O₅), and
   (iii) about 0.7 to about 4 percent by weight iron oxide (Fe₂O₃);
   wherein the percentages of phosphorus and iron oxide are based on the total amount of phosphorus or iron oxide in the pentasil containing catalyst/additive composition; wherein the regenerated catalyst comprises a carbon content of from about 0.005 to about 0.30% by weight, based on the total weight of the catalyst inventory;
(c) stripping recovered used catalyst particles in the catalyst inventory with a stripping steam in the stripper to remove therefrom some hydrocarbonaceous material or coke;
(d) recovering stripped hydrocarbons from the stripper and circulating the stripped catalyst particles to the regenerator;
(e) regenerating said cracking catalyst particles in a regeneration zone by burning-off a substantial amount of coke on said catalyst particles at a temperature sufficient to produce a carbon content of about 0.30% by weight or less on the total regenerated catalyst inventory;
(f) recycling said regenerated catalyst inventory to the reactor for continuing the cracking process.

The pentasil containing catalyst/additive composition may be used in the catalyst inventory of the inventive FCC process as the sole catalyst or as an additive. In addition, the pentasil containing catalyst/additive composition may be used in combination with separate particles of a conventional FCC catalyst containing no pentasil zeolite, e.g. an FCC catalyst comprising a faujasite zeolite.

As described above, the process of the present disclosure has been found to dramatically improve light olefins yield. For instance, the product stream may contain propylene in an amount from about 4.5% by weight to about 40% by weight. The product stream may also contain ethylene in an amount from about 0.5% by weight to about 25% by weight.

The present disclosure is also directed to a regenerated fluid catalytic catalyst composition comprising the pentasil containing catalyst/additive composition which when recycled during a fluidized cracking process, produces hydrocarbon products having increased light olefins yields and selectivity.

In one embodiment, the pentasil containing catalyst/additive composition used in the regenerated catalyst inventory comprise at least at least 10 wt % pentasil zeolite, such as ZSM-5, about 4.0% by weight or less, preferably about 2.5% by weight or less, iron oxide, and about 20% by weight, preferably about 19% by weight or less, more preferably about 18% by weight or less, but at least about 5% by weight or greater, phosphorus (measured as P₂O₅).

The regenerated catalyst inventory used in the process of the invention comprise carbon in an amount less than about 0.30% by weight, preferably less than about 0.25% by weight, more preferably less than about 0.20% by weight, even more preferably less than about 0.15% by weight, most preferably less than about 0.1% but, in either case, in an amount not less than about 0.005% by weight, carbon on the total catalyst inventory.

Other features and aspects of the present disclosure are discussed in greater detail below.

### BRIEF DESCRIPTION OF THE FIGURES

A full and enabling disclosure of the present disclosure is set forth more particularly in the remainder of the specification, including reference to the accompanying figures, in which:

FIG. 1. Shows the effect of iron oxide level in a catalyst on surface area stability under cyclic propylene steaming conditions (CPS). Loss in surface area stability is observed with incremental increase of iron oxide in catalyst.

FIG. 2. Shows surface area of iron oxide modified catalyst after 24 h hydrothermal deactivation. No loss in surface area was observed with incremental increase of iron oxide in catalyst.

FIG. 3. Shows below 0.30 wt % carbon on regenerated catalyst, the sample modified with iron oxide has higher propylene activity compared to the non-iron oxide modified sample. Above 0.30 wt % carbon on catalyst, the propylene activity drops significantly.

FIG. 4. Shows at all levels of coke on catalyst, the catalysts modified with iron oxide has higher selectivity for ethylene plus propylene at constant total wet gas (Hydrogen plus C1 to C4 hydrocarbons) compared to the base catalyst without iron oxide in the catalyst composition.

### DEFINITIONS

As used herein, the weight % of iron, and phosphorus are based on the amount of each of the above components contained in the pentasil containing catalyst/additive particles. The amount of iron in the pentasil containing catalyst/additive particles is measured as iron oxide and the amount of phosphorus contained in the pentasil containing catalyst/additive particles is measured as P₂O₅.

The term “mean particle size” is used herein to indicate the average of relative amount, by volume, of particles present according to size in the sample measured using a laser diffraction technique. The equipment used is a Mastersizer 3000 available from Malvern P analytical, which uses the technique of laser diffraction to measure particle size distribution.

The term “catalytic cracking activity” is used herein to mean the ability of a catalyst to reduce a higher molecular weight hydrocarbon (high boiling) feed to lower molecular weight hydrocarbon (low boiling) products.

The term “fluid catalytic cracking conditions” is used herein to mean operating conditions used for contacting hydrocarbon feed and catalyst particles, eg. contact time, temperature, and cat-to-oil ratio to reduce a higher molecular weight hydrocarbon (high boiling point) feed to a lower molecular weight hydrocarbon (low boiling point) products, during a fluidized catalytic cracking process.

The term “coked catalyst” is used herein to mean a FCC cracking catalyst that has exited from the riser and stripper during an FCC process. The coked catalyst is regenerated in the “regenerator” before it is recycled to riser in the FCCU during the cracking process.

### DETAILED DESCRIPTION

It is to be understood by one of ordinary skill in the art that the present discussion is a description of exemplary embodiments only, and is not intended as limiting the broader aspects of the present disclosure.

The present disclosure is directed to a fluid catalytic cracking process that increases the yield of light olefins, such as propylene, ethylene, and butylene as well as increase the selectivity for C2- and C3-olefins. In general, the process is directed to the use of a regenerated catalyst inventory having a reduced carbon content and comprising phosphorous stabilized pentasil zeolite containing catalyst/additives particles having a low content of iron oxide, wherein said regenerated catalyst inventory comprise a reduced amount of carbon. It has been discovered that the yield of light olefins can be greatly increased by not only maintaining relatively minor amounts of iron in the pentasil containing catalyst/additive composition but also maintaining the iron in an oxidized state by minimizing reductants, such as carbon on the total regenerated catalyst inventory.

### Pentasil Catalyst/Additives

Zeolites suitable for use in the pentasil containing catalyst/additive composition useful in the present disclosure comprise those zeolite structures having a five-membered ring in the structure's framework. The framework comprises silica and alumina in tetrahedral coordination. In one embodiment, the catalyst composition comprises one or more pentasils having an X-ray diffraction pattern of ZSM-5 or ZSM-11. Commercially available synthetic shape selective zeolites are also suitable.

The pentasil zeolites can generally have a Constraint Index of 1-12. Details of the Constraint Index test are provided in J. Catalysis, 67, 218-222 (1981) and in U.S. Pat. No. 4,711,710. Such pentasils are exemplified by intermediate pore zeolites, e.g., those zeolites having pore sizes of from about 4 to about 7 Angstroms. The pentasil can have a silica to alumina molar ratio (SiO₂/Al₂O₃), e.g., less than 300:1, such as less than 100:1, such as less than 50:1. In one embodiment, the pentasil has a silica to alumina ratio less than 30:1. The pentasil may also be exchanged with metal cations. Suitable metals include alkaline earth metals, transition metals, rare earth metals, phosphorus, boron, noble metals and combinations thereof.

Catalyst/additives particles generally comprise pentasil zeolite in an amount generally sufficient to enhance the light olefins yield. Generally, the pentasil zeolite catalyst/additives comprise pentasil in a range of about 10 to about 80%, preferably from about 20 to about 70% by weight, most preferably, from about 40 to about 60% by weight pentasil zeolite in the catalyst additive composition.

### Phosphorus

The pentasil containing catalyst/additive composition typically contain phosphorus (measured as (P₂O₅) in an amount less than about 20% by weight, and generally greater than about 5% by weight phosphorus, when measured as phosphorus pentoxide. For instance, phosphorus may be present in an amount greater than about 7% by weight, such as in an amount greater than about 9% by weight, such as in an amount greater than about 11% by weight, and generally in an amount less than about 18% by weight.

The phosphorus employed is selected to stabilize the pentasil zeolite, in the catalyst/additive composition and in combination with other ingredients, to act as a binder. It is measured as phosphorus pentoxide (P₂O₅). Without being held to a particular theory, it is believed that the phosphorus reacts with the pentasil's alumina acidic sites, thereby stabilizing the site with respect to any dealumination that can occur during use under typical fluid catalytic cracking conditions or under even more severe conditions. The phosphorus therefore stabilizes the pentasil's activity with respect to converting hydrocarbon molecules in the naphtha range, and thereby enhances the light olefins yield in FCC processes. The phosphorus can be added to the pentasil prior to, during, or after, forming catalyst/additive particles containing the pentasil. Phosphorus-containing compounds suitable as a source of phosphorus for this invention include phosphoric acid (H₃PO₄), phosphorous acid (H₃PO₃), salts of phosphoric acid, salts of phosphorous acid and mixtures thereof. Ammonium salts such as monoammonium phosphate (NH₄)H₂PO₄, diammonium phosphate (NH₄)₂HPO₄, monoammonium phosphite (NH₄)H₂PO₃, diammonium phosphite (NH₄)₂HP0₃, and mixtures thereof can also be used. Other compounds include phosphines, phosphonic acid, phosphonates and the like.

The phosphorous is added in amounts during manufacture of the catalyst/additive composition such that, on the basis of the particles containing the pentasil, the amount of phosphorus can range from about 5 to 20% by weight, preferably from about 7 to about 19% by weight, even from about 9 to 18% by weight, or from about 11 to 18%.

### Iron Oxide

The iron present in the pentasil containing catalyst/additive composition is measured as iron oxide. In general, the catalyst/additive composition contain iron oxide in an amount of about 4% by weight or less than, such as in an amount of about 3.0% by weight or less, such as in an amount of about 2.5% by weight or less, such as in an amount of about 2.3% by weight or less, such as in an amount of about 2% by weight or less, such as in an amount of about 1.8% by weight or less. The iron oxide is generally present in an amount greater than about 0.7% by weight, such as in an amount greater than about 0.9% by weight, based on the total amount of iron oxide contained in the pentasil containing catalyst/additive composition. Typically, the amount of iron oxide ranges from about 0.7 to about 4.0% by weight, preferably about 0.9 to about 3% by weight, even about 0.9 to about 2.5% by weight, based on the amount of the pentasil containing catalyst/additive composition.

Iron or iron oxide amounts can come from the matrix, the zeolite, the binder, or from clay that may be present in the pentasil containing catalyst/additive composition. The iron is therefore typically found in the catalyst matrix or binder, as well as found within the pore structure of the pentasil. The iron may be present outside or inside of the pentasil framework. By “outside the pentasil framework” it is meant iron that is outside of a coordinate of the silica/alumina tetrahedral structure. The iron can include iron associated with an acid site of the framework, e.g., as a cation exchanged onto the site. The iron can be present outside the pentasil zeolite i.e. in a matrix contained in the pentasil containing catalyst/additive composition.

Indeed, the iron referenced as a component of the pentasil containing catalyst/additive is generally iron that is separately added to and in combination with the other raw materials used to make the catalyst/additive composition. While the iron is described herein as an iron oxide (i.e., Fe₂O₃), it is further believed that the iron in the composition can exist in other forms, such as iron phosphate. The actual form however does depend on how the iron is introduced to the catalyst/additive composition. For example, the iron can be in the form of iron oxide in embodiments where iron is added as an insoluble iron oxide. On the other hand, if the iron is added as a water-soluble salt, the iron may react with an anion to form, e.g., iron phosphate, when a ferric halide is added to a spray drier feed mixture containing phosphoric acid. Nevertheless, iron oxide has been selected to reflect the iron portion of the composition in large part because analytical methods typically used in the industry to measure the content of iron and other metals typically report their results in terms of their oxides.

### Optional Components

In addition to iron oxide and phosphorous, the pentasil containing catalyst/additive composition contains additional components such as clay and a suitable matrix, and optionally binder materials.

The amount of matrix present in the catalyst/additive composition can vary widely. The matrix component may be present in the catalyst composition in amounts ranging from 0 to about 60 weight percent. The matrix is typically an inorganic oxide that has activity with respect to modifying the product of the FCC process, and in particular, activity to produce naphtha range olefinic molecules, upon which the pentasils described above can act. Inorganic oxides suitable as matrix include, but are not limited to, non-zeolitic inorganic oxides, such as silica, alumina, silica-alumina, magnesia, boria, titania, zirconia, metal phosphates, and mixtures thereof. In certain embodiments, the matrix comprises alumina in an amount from about 10 to about 50 weight percent of the total catalyst/additive composition. In other embodiments, the matrix comprises alumina in an amount greater than about 3% by weight and in an amount less than about 10% by weight.

The pentasil containing catalyst/additive composition may include one or more of various known clays, such as montmorillonite, kaolin, halloysite, bentonite, attapulgite, and the like. Other suitable clays include those that are leached by acid or base to increase the clay's surface area, e.g., increasing the clay's surface area to about 50 to about 350 m²/g, as measured by BET.

Suitable clays also include iron-containing clays, sometimes referred to as hard kaolin clays or “gray” clay. The latter term is sometimes used because these hard kaolin clays have a gray tinge or coloration. Hard kaolin clays are reported to have significant iron content, usually from about 0.6 to about 5 weight percent of Fe₂O₃. In embodiments containing gray clays, the iron content therein can be included as part of the iron oxide employed. Given the amount of iron typically used, however, and the fact the iron in these clays is in a form that is not always readily reactive, it would be preferred to employ additional sources of iron.

The matrix and clays are usually provided and incorporated into the catalyst/additive composition when formulating as particles. When preparing the composition from a blend of pentasil containing particles. The matrix can have a surface area of at least about 5 m²/g, preferably about 15 to about 130 m²/g. Matrix surface area can be measured by employing a t-plot analysis based on ASTM 4365-95. The total surface area of the catalyst/additive composition is generally at least about 50 m²/g, either fresh or as treated at 816° C. for four hours at 100% steam. Total surface area can be measured using BET.

Suitable materials for optional binders include inorganic oxides, such as alumina, silica, silica-alumina, aluminum phosphate, as well as other metal-based phosphates known in the art. Aluminum chlorohydrol may also be used as a binder. When using metal phosphate binders other than aluminum phosphate, the metal can be selected from the group consisting of Group IIA metals, lanthanide series metals, including scandium, yttrium, lanthanum, and transition metals. In certain embodiments Group VIII metal phosphates are suitable. In one embodiment the fresh pentasil containing catalyst/additive composition used to form the regenerated catalyst is prepared as an aqueous slurry containing the various ingredients, e.g. pentasil zeolite, phosphorous, and iron oxide, clay, optional matrix materials in amounts described herein above. For instance, in one embodiment, the aqueous slurry can contain pentasil zeolite, iron oxide, a phosphate, alumina, and/or clay. The resulting aqueous slurry is well mixed and then spray dried.

Other methods for preparing the pentasil containing catalyst/additive composition include, but are not limited to, the following general processes:

(1) Ion exchanging or impregnating a selected pentasil zeolite with iron, and incorporating the ion exchanged or impregnated zeolite into the optional components mentioned earlier and form the catalyst/additive composition.

(2) Combining an iron source with pentasil zeolite and optional components simultaneously and forming the desired catalyst/additive composition.

(3) Manufacturing a pentasil containing catalyst in a conventional manner, e.g., forming a pentasil composition comprising the pentasil zeolite and optional components mentioned earlier, and subjecting the formed catalyst particles to ion exchange to include iron.

(4) Preparing a conventional catalyst/additive composition as mentioned in (3), except the pentasil containing catalyst/additive particle is impregnated, e.g., via incipient wetness, with iron precursor to include iron.

In one embodiment, after combining the exchanged pentasil zeolite of (1) with the optional components in water, the resulting slurry can be spray dried into particles having an average particle size in the range of about 20 to about 200 microns, such as from 20 to about 100 microns, and the resulting catalyst/additive composition is then processed under conventional conditions.

The source of iron in any of the above methods can be in the form of an iron salt, and includes, but is not limited to iron halides such as chlorides, fluorides, bromides, and iodides. Iron carbonate, sulfate, phosphates, nitrates and acetates are also suitable sources of iron. The source of the iron can be aqueous-based, and iron can be present in the exchange solution at concentrations of about 1 to about 30%. When incorporating the iron via an exchange method, the exchange can be conducted such that at least 10% of the exchange sites present on the zeolite are exchanged with iron cations. The iron can also be incorporated through solid state exchange methods.

When impregnating the pentasil zeolite or pentasil zeolite containing catalyst/additive using method (1) or method (4), an iron source, usually in aqueous solution, is added to pentasil zeolite powder or catalyst particles until incipient wetness. The concentrations of iron for typical impregnation baths are in the range of 0.5 to 20%.

The source of iron for methods (1) and (2) can also be forms of iron such as iron oxide, wherein such sources are not necessarily soluble, and/or the solubility of which depends on the pH of the media to which the iron source is added.

The matrix and binder may be added to the pentasil zeolite mixture as dispersions, solids, and/or solutions. A suitable clay matrix comprises kaolin. Suitable dispersible sols include alumina sols and silica sols known in the art. Suitable alumina sols are those prepared by peptizing alumina using strong acid. Particularly suitable silica sols include Ludox® colloidal silica available from W.R. Grace & Co.-Conn. Certain binders, e.g., those formed from binder precursors, e.g., aluminum chlorohydrol, are created by introducing solutions of the binder's precursors into the mixer, and the binder is then formed upon being spray dried and/or further processed, e.g., calcination.

The final pentasil containing catalyst/additive composition preferably has an attrition resistance suitable to withstand conditions typically found in FCC processes. Preparing catalysts to have such properties is often made using the Davison Attrition Index (DI). The lower the DI number, the more attrition resistant is the catalyst. Commercially acceptable attrition resistance is indicated by a DI of less than about 20, preferably less than 10, and most preferably less than 5.

### Regenerated Catalyst

Once the pentasil containing catalyst/additive composition is prepared, the composition can be used to make up 100% of a catalyst inventory, or it can be added to a catalyst inventory as an additive, e.g., as an “light olefins additive”, or it can be combined with separate particles of a conventional FCC cracking catalyst and/or additives, which contain no pentasil zeolite, to form the cracking catalyst inventory. In general, pentasil containing catalyst/additive composition can comprise about 0.5 to about 99%, such as from about 1 to about 60%, such as from about 1 to about 30% by weight of the total catalyst inventory.

The conventional FCC catalyst may comprise any FCC catalyst composition containing additional zeolites having catalytic cracking activity in a fluid hydrocarbon conversion process other than pentasil zeolites, and conventional components, e.g. clays, matrix, binders etc. . . . . Typically, the additional FCC catalyst particle will comprise a large pore size zeolite having a pore structure with an opening of at least 0.7 nm.

Suitable large pore zeolites comprise crystalline aluminosilicate zeolites such as synthetic faujasite, i.e., type Y zeolite, type X zeolite, and Zeolite Beta, as well as heat treated (calcined) and/or rare earth exchanged derivatives thereof. Zeolites that are particularly suited include calcined, rare earth exchanged type Y zeolite (CREY), ultra-stable type Y zeolite (USY), as well as various partially exchanged type Y zeolites. Other suitable large pore zeolites include MgUSY, ZnUSY, MnUSY, P-USY, HY, REY, CREUSY, REUSY zeolites, and mixtures thereof. The zeolite may also be blended with molecular sieves such as SAPO and ALPO.

Standard Y-type zeolite is commercially produced by crystallization of sodium silicate and sodium aluminate. This zeolite can be converted to USY-type by dealumination, which increases the silicon/aluminum atomic ratio of the parent standard Y zeolite structure. Dealumination can be achieved by steam calcination or by chemical treatment. The additional zeolite based cracking catalyst can also be formed from clay microspheres that have been “zeolitized” in situ to form zeolite Y. Briefly, the zeolite Y is formed from calcined clay microspheres by contacting the microspheres to caustic solution at 180° F. (82° C.) “Commercial Preparation and Characterization of FCC Catalysts”, Fluid Catalytic Cracking: Science and Technology, Studies in Surface Science and Catalysis, Vol. 76, p. 120 (1993).

Rare earth exchanged zeolites that can be used are prepared by ion exchange, during which sodium atoms present in the zeolite structure are replaced with other cations, usually as mixtures of rare earth metal salts such as those salts of cerium, lanthanum, neodyminum, naturally occurring rare earths and mixtures thereof to provide REY and REUSY grades, respectively. These zeolites may be further treated by calcinations to provide the aforementioned CREY and CREUSY types of material. MgUSY, ZnUSY and MnUSY zeolites can be formed by using the metal salts of Mg, Zn or Mn or mixtures thereof in the same manner as described above with respect to the formation of REUSY except that salts of magnesium, zinc or manganese is used in lieu of the rare earth metal salt used to form REUSY.

The unit cell size of a preferred fresh Y-zeolite is about 24.35 to 24.7 Å. The unit cell size (UCS) of zeolite can be measured by X-ray analysis under the procedure of ASTM D3942. There is normally a direct relationship between the relative amounts of silicon and aluminum atoms in the zeolite and the size of its unit cell. Although both the zeolite, per se, and the matrix of a fluid cracking catalyst usually contain both silica and alumina, the SiO₂/Al₂O₃ ratio of the catalyst matrix should not be confused with that of the zeolite. When an equilibrium catalyst is subjected to X-ray analysis, it only measures the UCS of the crystalline zeolite contained therein.

The unit cell size value of a Y zeolite also decreases as it is subjected to the environment of the FCC regenerator and reaches equilibrium due to removal of the aluminum atoms from the crystal structure. Thus, as the Y zeolite in the FCC inventory is used, its framework Si/Al atomic ratio increases from about 3:1 to about 30:1. The unit cell size correspondingly decreases due to shrinkage caused by the removal of aluminum atoms from the cell structure. The unit cell size of a preferred equilibrium Y zeolite is at least 24.22 Å, preferably from 24.24 to 24.50 Å, and more preferably from 24.24 to 24.40 Å.

In general, the amount of non-pentasil zeolite present in the conventional FCC catalyst particles will be an amount sufficient to produce molecules in the gasoline range olefins. For example, the additional FCC catalyst composition can comprise about 1 to about 99.5% by weight of a zeolite, other than pentasil, e.g., Y-type zeolite, with specific amounts depending on amount of activity desired. More typical embodiments comprise about 10 to about 80%, and even more typical embodiments comprise about 13 to about 70% additional zeolite.

The conventional FCC catalyst may be present in the regenerated catalyst in an amount sufficient to provide the desired cracking activity. Generally, the amount of conventional FCC catalyst will be present in the regeneration catalyst in amounts ranging from about 0.5 to about 99% by weight, preferably from about 40 to about 99% by weight, most preferably from about 70 to about 99% by weight, of the total regenerated catalyst.

### Preparation of the Regenerated Catalyst

The regenerated catalysts used in the present invention are prepared by forming an initial fluidazable catalyst inventory using conventional means, such that the inventory comprises the desired amount of pentasil containing catalyst/additive composition, and optional separate particles of conventional FCC catalyst and/or additives, and recycling the catalyst inventory throughout the FCCU to provide a coked catalyst. The coked catalyst is thereafter recycled to the regenerator of FCCU under conditions sufficient to provide a regenerated catalyst inventory comprising carbon in an amount less than about 0.30% by weight, such as an amount of less than about 0.25% by weight, such as in an amount less than about 0.22% by weight, such as in an amount less than about 0.20% by weight, such as in an amount less than about 0.18% by weight, such as in an amount less than about 0.15% by weight, such as in an amount less than about 0.10% by weight, such as in an amount less than about 0.08% by weight, such as in an amount less than about 0.05% by weight, such as in an amount less than about 0.03% by weight, such as in an amount less than about 0.01% by weight. Typically, the amount of amount of carbon content on the regenerated catalyst will be higher than 0.005%. Generally, the amount of carbon on the total catalyst inventory ranges from about 0.005 to about 0.30% by weight, even from about 0.25 to about 0.1% by weight, of the regenerated catalyst inventory.

The regenerated catalyst composition has an attrition resistance suitable to withstand conditions typically found in FCC processes. Preferably, the catalyst composition has a DI of less than about 20, preferably less than 10, and most preferably less than 5.

### FCC Processes

The process of the invention is particularly suitable for use in conventional FCC processes where hydrocarbon feedstocks are cracked into lower molecular weight compounds in the absence of added hydrogen. Typical FCC processes entail cracking a hydrocarbon feedstock in a cracking reactor unit (FCCU) or reactor stage in the presence of fluid cracking catalyst particles to produce liquid and gaseous product streams. The product streams are removed and the catalyst particles are subsequently passed to a regenerator stage where the particles are regenerated by exposure to an oxidizing atmosphere to remove contaminant coke. More particularly, in accordance with the present disclosure, the catalyst particles are regenerated while being exposed to regenerator conditions in order to reduce carbon levels in the catalyst composition to at least below 0.3% by weight. The regenerated particles are then circulated back to the cracking zone to catalyze further hydrocarbon cracking. In this manner, an inventory of catalyst particles comprising the regenerated catalyst is circulated throughout the FCCU during the overall cracking process.

The FCC unit can be run using conventional conditions, wherein the reaction temperatures range from about 400° to 700° C. with regeneration occurring at temperatures of from about 500° to 900° C. The particular conditions depend on the petroleum feedstock being treated, the product streams desired, and other conditions well known to refiners. For example, lighter feedstock can be cracked at lower temperatures. The catalyst composition (i.e., inventory) is circulated through the unit in a continuous manner between catalytic cracking reaction and regeneration while maintaining the equilibrium catalyst in the reactor.

The regenerated FCC catalyst composition and process as disclosed herein can be used in various fluid cracking processes that employ pentasil zeolite-containing catalyst/additives. Such processes may include Deep Catalytic Cracking (DCC), Catalytic Pyrolysis Process (CPP), High-Severity Fluid Catalytic Cracking (HS-FCC), KBR Catalytic Olefins Technology (K-COT™), Superflex™. Ultimate Catalytic Cracking (UCC). Conditions for these processes, and typical operating conditions, are listed in the table below.

| | | | | KCOT/ | | |
|---|---|---|---|---|---|---|
| | FCC | DCC | HS-FCC | Superflex | CPP | UCC |
| Temperature, ° C. | 500-550 | 505-575 | 570-610 | 650-680 | 560-650 | 550-570 |
| Cat./Oil | 5 to 10 | 9 to 15 | 13 to 30 | NR | 15 to 25 | 18 to 22 |
| Reactor Pressure, | 1 to 2 | 0.7 to 1.5 | 1 | 1.5 | 0.8 | 1 to 4 |
| atmospheres | | | | | | |
| Steam Dilution, | 1 to 3 | 5 to 30 | 1 to 3 | NR | 30 to 50 | 20 to 35 |
| wt % of feed | | | | | | |
| WHSV | 125 to | 0.2 to 20 | | NR | NR* | 50 to 80 |
| | 200 | | | | | |
| Feed Type | VGO, | VGO, | VGO, | Naphtha | VGO, | VGO, |
| | Resid | Light | Resid | | Resid | Resid |
| | | Paraffinic | | | | |
| | | Feed | | | | |

*NR = not reported

The catalyst composition can be used to crack a variety of hydrocarbon feedstocks. Typical feedstocks include in whole or in part, a gas oil (e.g., light, medium, or heavy gas oil) having an initial boiling point above about 30° C. and an end point up to about 850° C. The feedstock may also include deep cut gas oil, vacuum gas oil, thermal oil, residual oil, cycle stock, whole top crude, tar sand oil, shale oil, synthetic fuel, heavy hydrocarbon fractions derived from the destructive hydrogenation of coal, tar, pitches, asphalts, hydrotreated feedstocks derived from any of the foregoing, and the like. In one embodiment, the feedstock may be a naphtha feed with boiling point less than 120° C. As will be recognized, the distillation of higher boiling petroleum fractions above about 400° C. must be carried out under vacuum in order to avoid thermal cracking. The boiling temperatures utilized herein are expressed in terms of convenience of the boiling point corrected to atmospheric pressure.

While improvement in propylene yields vary with feedstock and FCC conditions, employing the catalyst composition in conventionally run FCC units running on typical feedstock and at about 75% conversion can result in improved propylene yield of at least 0.1% based on feedstock, preferably at least 3% and most preferably at least 7% compared to processes using catalyst that does not contain the catalyst composition of the present disclosure. LPG (C3 to C4 range hydrocarbons) yields from processes using the catalyst composition can be at least 0.1% by weight of feedstock, preferably at least 5% and most preferably at least about 12% by weight higher compared to processes using catalyst that does not contain the catalyst composition of the present disclosure.

For example, in one embodiment, the product stream contained from the fluid catalytic cracking unit can contain propylene in an amount greater than about 4.5% by weight, such as in an amount greater than about 10% by weight, such as in an amount greater than about 20% by weight. Ethylene can be contained in the product stream in an amount greater than about 0.5% by weight, such as in an amount greater than about 1.5% by weight, such as in an amount greater than about 2% by weight. Ethylene is generally contained in the product stream in an amount less than about 25% by weight, and propylene is generally contained in the product stream in an amount less than about 40% by weight.

To further illustrate the present disclosure and the advantages thereof, the following specific examples are given. The examples are given for illustrative purposes only and are not meant to be a limitation on the claims appended here to. It should be understood that the present disclosure is not limited to the specific details set forth in the examples.

All parts and percentages in the examples, as well as the remainder of the specification, which refers to solid compositions or concentrations, are by weight unless otherwise specified. However, all parts and percentages in the examples as well as the remainder of the specification referring to gas compositions are molar or by volume unless otherwise specified.

The present disclosure may be better understood with reference to the following examples.

### EXAMPLES

The following examples demonstrate some of the advantages and benefits of catalyst compositions formulated in accordance with the present disclosure.

The amounts of iron oxide and phosphorus pentoxide in the pentasil zeolite catalyst/additive composition were determined according to Inductively Coupled Plasma (ICP) and X-ray Florescence Spectroscopy (XRF). The carbon contained onto the regenerated catalyst inventory is measured by LECO Carbon Analyzer.

The term “Davidson Attrition Index (DI) was determined by taking 7.0 cc of sample catalyst. The sample catalyst is screened to remove particles in the 0 to 20 micron range. Those remaining particles are then contacted in a hardened steel jet cup having a precision bored orifice through which an air jet of humidified (60%) air is passed at 21 liter/minute for 1 hour. The DI is defined as the percent of 0-20 micron fines generated during the test relative to the amount of >20 micron material initially present, i.e., the formula below.

$$DI = 100 \times \frac{wt \% of 0 - 20 micron material formed during test}{wt \% of original 20 microns or greater material before test}$$

DI is described in Cocco et al., Particle Attrition Measurement Using Jet Cup, the 13^{th} International Conference on Fluidization-New Paradigm in Fluidization Engineering, Art. 17 [2010].

### Comparative Example 1

Comparative Catalysts 1 and 3 were prepared without added iron compound. Dry ZSM-5 powder was slurried up in water. To this slurry was added alumina, kaolin clay, and concentrated (85%) H₃PO₄. The slurry was mixed in a high shear mixer, milled in a Drais media mill and then spray dried. The Bowen spray dryer was operated at a 400° C. inlet temperature and a 150° C. outlet temperature. The spray dried catalyst was calcined for 40 minutes at 593° C. The formulation of the comparative catalysts 1 and 3 and their resulting properties are shown in Table 1 and 2. All the Fe2O3 in the catalyst comes from the clay.

### Comparative Example 2

Comparative Catalyst 2, with 4.6% Fe2O3, was prepared by the following procedure. Dry ZSM-5 powder was slurried up in water. To this slurry was added alumina, kaolin clay, FeCl₂.4H2O powder and concentrated (85%) H₃PO₄. The slurry was mixed in a high shear mixer, milled in a Drais media mill and then spray dried. The Bowen spray dryer was operated at a 400° C. inlet temperature and a 150° C. outlet temperature. The spray dried catalyst was calcined for 40 minutes at 593° C. The formulation of Comparative Catalyst 2 and its resulting properties are shown in Table 1.

### Example 1: 40% ZSM-5 Additives with 0.6 to 3.4% Fe2O3

A series of ZSM-5 catalysts with 0.6 to 3.4% Fe2O3 were prepared by the following procedure. Dry ZSM5 powder was slurried up in water. To this slurry was added alumina, kaolin clay, FeCl₂.4H2O powder and concentrated (85%) H₃PO₄. The slurry was mixed in a high shear mixer, milled in a Drais media mill and then spray dried. The Bowen spray dryer was operated at a 400° C. inlet temperature and a 150° C. outlet temperature. The spray dried catalyst was calcined for 40 minutes at 593° C. The formulation of the Catalysts A to C and their resulting properties are shown in Table 1.

TABLE 1

| | Comparative | | | | Comparative |
|---|---|---|---|---|---|
| Sample | Catalyst 1 | Catalyst A | Catalyst B | Catalyst C | Catalyst 2 |
| Pentasil Zeolite, wt % | 40 | 40 | 40 | 40 | 40 |
| Alumina, wt % | 6 | 6 | 6 | 6 | 6 |
| P2O5, wt % | 13 | 14 | 15 | 16 | 17 |
| Added Fe2O3, wt % | 0 | 1 | 2 | 3 | 4 |
| Clay, wt % | 41 | 39 | 37 | 35 | 33 |
| ABD, g/cm³ | 0.70 | 0.70 | 0.70 | 0.70 | 0.71 |
| Davison-Attrition | | | | | |
| Index (DI) | 5 | 8 | 7 | 6 | 6 |
| Al₂O₃, % | 26 | 25 | 24 | 23 | 22 |
| Na2O % | 0.2 | 0.2 | 0.2 | 0.2 | 0.2 |
| P₂O₅, % | 13 | 14 | 15 | 16 | 17 |
| Fe₂O₃, % | 0.6 | 1.6 | 2.6 | 3.4 | 4.6 |

Deactivated Properties: CPS Steaming at 1480 F

| | | | | | |
|---|---|---|---|---|---|
| SA, m²/g | 131 | 110 | 96 | 75 | 60 |

Deactivated Properties: Hydrothermal Steaming at 1500 F (4 hours, 100% steam)

| | | | | | |
|---|---|---|---|---|---|
| SA, m²/g | 125 | 121 | 119 | 122 | 124 |

### Example 2: 55% ZSM-5 Additives with 0.4 to 3.1% Fe2O3

A series of ZSM-5 catalysts with 0.4 to 3.1% Fe2O3 were prepared by the following procedure. Dry ZSM-5 powder was slurried up in water. To this slurry was added concentrated (85%) H₃PO₄, soluble iron salt, alumina and kaolin clay. The slurry was mixed in a high shear mixer, milled Drais media mill and then spray dried. The Bowen spray dryer was operated at a 400° C. inlet temperature and a 150° C. outlet temperature. The spray dried catalyst was calcined for 2 hours at 593° C. The formulation of the catalysts (Catalyst D to H) and their resulting properties are shown in Table 2.

TABLE 2

| | Comparative | | | | | |
|---|---|---|---|---|---|---|
| Sample | Catalyst 3 | Catalyst D | Catalyst E | Catalyst F | Catalyst G | Catalyst H |
| Pentasil Zeolite, wt % | 55 | 55 | 55 | 55 | 55 | 55 |
| Alumina, wt % | 6 | 6 | 6 | 6 | 6 | 6 |
| P2O5, wt % | 13.5 | 13.7 | 13.9 | 14.1 | 14.4 | 15.3 |
| Added Fe2O3, wt % | 0 | 0.3 | 0.6 | 1 | 1.5 | 3 |
| Clay, wt % | 25.5 | 25 | 24.5 | 23.9 | 23.1 | 20.7 |
| ABD, g/cm³ | 0.70 | 0.70 | 0.70 | 0.70 | 0.71 | 0.72 |
| Davison Attrition | 4 | 7 | 7 | 6 | 4 | 6 |
| Index (DI) | | | | | | |
| Al₂O₃, % | 19.1 | 19.3 | 18.9 | 18.6 | 18.4 | 18.5 |
| P₂O₅, % | 13.9 | 14.1 | 14.2 | 14.6 | 14.9 | 15.2 |
| Fe₂O₃, % | 0.4 | 0.6 | 0.8 | 1.2 | 1.7 | 3.1 |

Deactivated Properties: CPS Steaming at 1480 F

| | | | | | | |
|---|---|---|---|---|---|---|
| SA, m²/g | 202 | 199 | 198 | 188 | 158 | 131 |

Deactivated Properties: Hydrothermal Steaming at 1500 F

| | | | | | | |
|---|---|---|---|---|---|---|
| SA, m²/g | 198 | 196 | 195 | 196 | 190 | 188 |

### Example 3: Steam Stability of Catalysts During Oxidation-Reduction Steam Deactivation Cycles

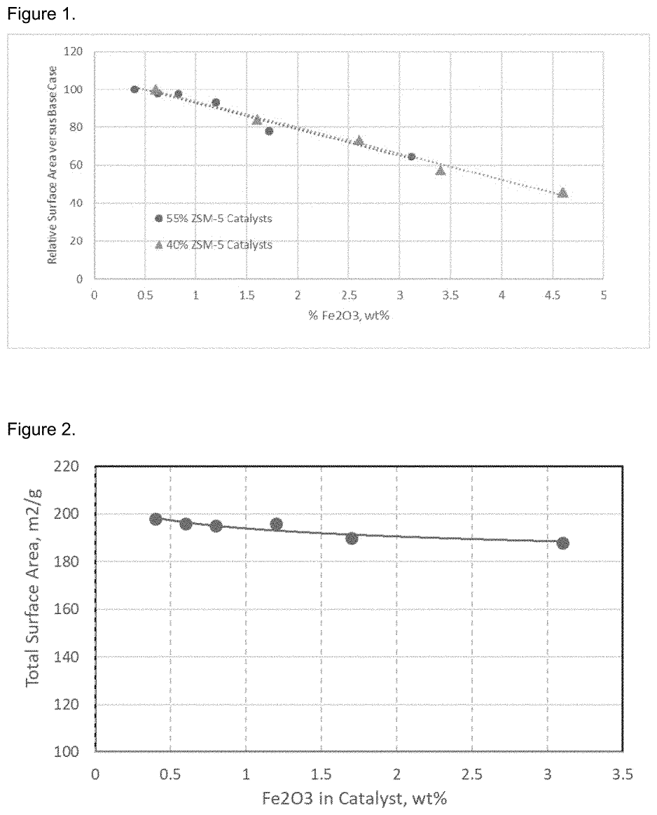

The iron oxide containing ZSM-5 Catalysts A-H and the Comparative Catalysts 1, 2 and 3 were deactivated, without any contaminant metals, by the Cyclic Propylene Steaming method (CPS), which includes oxidation/reduction cycles. The description of the CPS method has been published in D. Wallenstein, R. H. Harding, J. R. D Nee, and L. T. Boock, “Recent Advances in the Deactivation of FCC Catalysts by Cyclic Propylene Steaming in the Presence and Absence of Contaminant Metals” Applied Catalysis A, General 204 (2000) 89-106. The surface area of the catalysts, after deactivation is shown in Tables 1 and 2. The data is plotted in FIG. 1 shows that the oxidation-reduction cycles have a detrimental effect on surface area stability, when the catalyst contains higher levels of iron. This is particularly true above 4% Fe2O3, where >50% loss in surface area is observed versus the Base Comparative Catalysts 1 and 3, without any added Fe2O3.

### Example 4: Steam Stability of Catalysts During Hydrothermal Deactivation

The ZSM-5 Catalysts D-H and Comparative Catalyst 3 were deactivated by a 24-hour hydrothermal deactivation with 100% steam at 816° C. FIG. 2 shows the surface area of the catalysts after the 24-hour hydrothermal deactivation with 100% steam at 816° C. The data shows that there is minimal loss in surface area, with Fe2O3 present, when redox CPS steaming is not utilized.

### Example 5: Testing Performance after Oxidation-Reduction Steam Deactivation Cycles

Comparative Catalysts 1 and 2, and Catalysts A-C, deactivated by CPS in Example 3, were tested as blends with Aurora™ cracking catalyst, a commercially available FCC catalyst from W. R. Grace & Co.-Conn. The ZSM-5 additives were blended at a 5 wt % level with steam deactivated Aurora cracking catalyst and tested in an ACE Model AP Fluid Bed Microactivity unit at 527° C. Several runs were carried out for each catalyst using catalyst-to-oil ratios between 3 and 10. The catalyst-to-oil ratio was varied by changing the catalyst weight and keeping the feed weight constant. The feed weight utilized for each run was 1.5 g and the feed injection rate was 3.0 g/minute. The ACE hydrocarbon yields were interpolated to constant conversion to compare the catalysts. The properties of the feed are shown in Table 4. The ACE interpolated data (Table 5) shows that the Invention catalysts A-C show enhanced propylene yields versus the low (0.6% Fe2O3) and high iron (4.6% Fe2O3) Comparative Catalysts 1 and 2.

### Example 6: Effect of Oxidized Vs. Reduced Feⁿ⁺ on Light Olefins Yield

Comparative Catalyst 1 and Comparative Catalyst 2, deactivated by hydrothermal steam (24-hours at 816 C in 100% steam), were tested as deactivated (Comparative Catalyst 1 and Comparative Catalyst 2) and after reduction in hydrogen at 500° C. for 2 hours (Comparative Catalyst 1 (reduc) and Comparative Catalyst 2 (reduc)). The Fe2O3 is primarily in an oxidized state after deactivation and in a more reduced state after the reduction with hydrogen. Comparative Catalyst 1, Comparative Catalyst 1 (reduc), Comparative Catalyst 2, and Comparative Catalyst 2 (reduc), were tested as blends with Aurora™ cracking catalyst, a commercially available FCC catalyst from W. R. Grace & Co.-Conn. The testing conditions were the same as outlined in Example 5. The ZSM5 additives were blended at a 5 wt % level with steam deactivated Aurora cracking catalyst. The ACE hydrocarbon yields were interpolated to constant conversion to compare the catalysts. The properties of the feed are shown in Table 4. The ACE data (Table 6) shows that the low iron Comparative Catalyst 1 deactivated under oxidized and reduced conditions have very similar propylene yields, while a comparison of the high iron Comparative Catalyst 2 shows that the sample deactivated under oxidized conditions has significantly better propylene yield than the Comparative Catalyst 2 reduced in hydrogen. Comparative Catalyst 2 (reduc) has performance similar to Comparative Catalyst 1. This indicates that the iron needs to be in the oxidized state to enhance light olefins performance.

TABLE 4
Feed Properties:

| | |
|---|---|
| API Gravity | 24.7 |
| K Factor | 12.01 |
| Sulfur | 0.35 |
| Total Nitrogen | 0.14 |
| Conradson Carbon | 0.32 |
| Simulated Distillation, Volume % | |
| IBP | 275° C. |
| 10% | 366° C. |
| 30% | 412° C. |
| 50% | 553° C. |
| 70% | 498° C. |
| 90% | 563° C. |
| FBP | 682° C. |

TABLE 5

| | Comparative | Comparative | | | |
|---|---|---|---|---|---|
| | Catalyst 1 | Catalyst A | Catalyst B | Catalyst C | Catalyst 2 |
| Conversion | 75 | 75 | 75 | 75 | 75 |
| Cat to Oil | 6.1 | 5.7 | 6.3 | 6.1 | 5.5 |
| Ethylene, wt % | 0.81 | 1.05 | 1.15 | 0.91 | 0.84 |
| Propylene, wt % | 9.0 | 10.2 | 10.7 | 10.1 | 8.7 |
| C4-Olefins, wt % | 9.0 | 9.4 | 9.8 | 9.6 | 8.7 |
| Wet Gas, wt % | 28.0 | 30.2 | 31.9 | 29.8 | 27.1 |
| Gasoline, wt % | 44.0 | 41.8 | 40.0 | 42.3 | 45.1 |
| Light cycle oil, wt% | 19.3 | 19.2 | 19.4 | 19.4 | 19.3 |
| Bottoms, wt% | 5.7 | 5.8 | 5.6 | 5.6 | 5.7 |
| Coke, wt% | 3.0 | 3.0 | 3.1 | 2.9 | 2.8 |

TABLE 6

| | Comparative | Comparative | Comparative | Comparative |
|---|---|---|---|---|
| | Catalyst 1 | Catalyst 1 (reduc) | Catalyst 2 | Catalyst 2 (reduc) |
| Conversion | 76 | 76 | 76 | 76 |
| Cat-to-Oil Ratio | 6.1 | 6.1 | 6.0 | 6.2 |
| Ethylene, wt % | 0.7 | 0.7 | 1.3 | 0.8 |
| Total Dry Gas, wt % | 1.7 | 1.7 | 2.2 | 1.9 |
| Propylene, wt % | 8.2 | 8.3 | 10.8 | 8.0 |
| Total C4='s, wt % | 9.0 | 9.2 | 9.8 | 8.6 |
| Total Wet Gas, wt % | 26.2 | 26.6 | 31.0 | 26.3 |
| C5+ Gasoline, wt % | 47.1 | 46.7 | 42.3 | 46.6 |
| LCO, wt % | 18.4 | 18.4 | 18.2 | 18.5 |
| Bottoms, wt % | 5.6 | 5.6 | 5.8 | 5.5 |
| Coke, wt % | 2.7 | 2.6 | 2.7 | 3.0 |

### Example 7: Performance Effect of Carbon on the Regenerated Catalyst

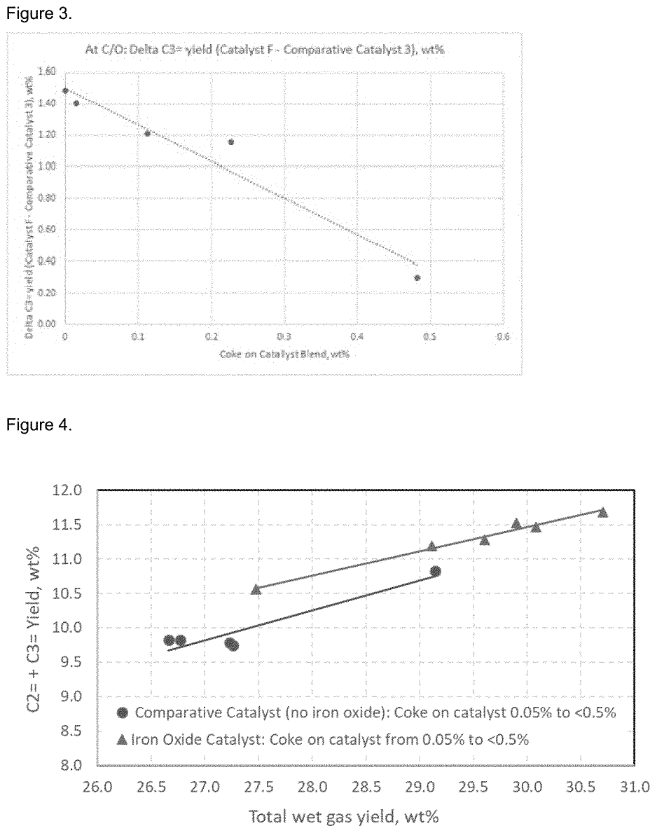

Comparative Catalyst 3 and Catalyst F were steamed hydrothermally for 24 h in 100% steam. The steamed catalyst was then blended with laboratory deactivated FCC base catalyst at a 5 wt % level. The catalyst blend was then coked in a pilot plant. The measured coke on catalysts were >0.6 wt %. The coked catalyst was then calcined at different temperatures to achieve target levels of coke on catalyst. The regenerated catalyst was then evaluated in ACE for propylene activity. The data shows below 0.30 wt % carbon on regenerated catalyst, the sample modified with Fe2O3 has significantly higher propylene activity compared to the non-Fe2O3 modified sample. Above 0.30 wt % carbon on catalyst, the propylene activity drops quickly, as shown in FIG. 3.

### Example 8: C2= and C3=Selectivity Advantage of Inventive Catalyst

Comparative Catalyst 2 and Catalyst F were steamed hydrothermally for 24 h in 100% steam. The steamed catalyst was then blended with laboratory deactivated FCC base catalyst at 5 wt %. The catalyst blend was then coked in a pilot plant. The measured coke on catalysts were >0.6 wt %. The coked catalyst was then calcined at different temperatures to achieve target coke levels (between 0.05% and <0.5%) on catalyst. The regenerated catalyst was then evaluated in ACE for ethylene plus propylene activity and selectivity. The data in FIG. 4 shows at all levels of coke on catalyst, the sample modified with Fe2O3 has higher selectivity for ethylene plus propylene at constant total dry gas (Hydrogen plus C1 to C2 hydrocarbons) compared to the non-Fe2O3 modified sample. The higher selectivity for C2- and C3-olefins is important for units which are constrained in wet gas compressor capacity. This allows refinery to maximize profitability by producing more C2- and C3-olefins at constant dry gas.

1. A fluidized cracking process comprising:
contacting a hydrocarbon feedstock with a circulating inventory of a regenerated fluid catalytic cracking catalyst composition to form a product stream;
wherein:
the regenerated fluid catalytic cracking catalyst composition has a carbon content of about 0.005% to about 0.30% by weight;
the regenerated fluid catalytic cracking catalyst composition comprises a pentasil containing catalyst/additive composition which comprises:
pentasil zeolite;
about 0.7 to about 4.0% by weight iron oxide; and
about 5.0 to about 20% by weight of a phosphorous (measured as P₂O₅).

2. The process of claim 1, wherein the regenerated fluid catalytic cracking catalyst composition has an average particle size of about 20 to about 200 microns.

3. The process of claim 1, wherein the iron oxide is present in in the pentasil containing catalyst/additive in an amount of about 0.9 to about 2.5% by weight.

4. The process of claim 1, wherein the phosphorous (measured as P₂O₅) is present in the pentasil containing catalyst/additive composition in an amount of from about 7% to about 18% by weight.

5. The process of claim 4, wherein the phosphorous (as P₂O₅) is present in the pentasil containing catalyst/additive composition in an amount of from about 9% to about 18% by weight.

6. The process of claim 1, wherein the regenerated fluid catalytic catalyst composition comprises carbon in an amount from about 0.01 to about 0.25% by weight.

7. The process of claim 1, wherein the contacting is conducted at a temperature of about 400° C. to about 700° C.

8. The process of claim 1, wherein the pentasil containing catalyst/additive composition contains the pentasil zeolite in an amount of greater than about 45% by weight.

9. The process of claim 1, wherein the product stream contains propylene in an amount greater than about 4.5% by weight.

10. The process of claim 1, wherein the product stream contains ethylene in an amount greater than about 0.5% by weight.

11. The process of claim 1, wherein the pentasil zeolite comprises ZSM-5 or ZSM 11.

12. The process of claim 1, wherein the regenerated catalyst composition exhibits a Davison Attrition Index of less than 20.

13. The process of claim 1, wherein the pentasil zeolite is ZSM-5.

14. The process of claim 1, wherein the inventory of regenerated fluid catalytic cracking catalyst further comprises separate particles of an additional cracking catalyst composition suitable for cracking hydrocarbons.

15. The process of claim 14, wherein the additional cracking catalyst composition comprises a faujasite zeolite.

16. (canceled)

17. The process of claim 1, wherein the fluid catalytic cracking process is one selected from the group consisting of Deep Catalytic Cracking (DCC), Catalytic Pyrolysis Process (CPP), High-Severity Fluid Catalytic Cracking (HS-FCC), KBR Catalytic Olefins Technology (K-COT™), and Superflex™′ Ultimate Catalytic Cracking (UCC).

18. A regenerated catalyst composition in a circulating catalyst inventory in a fluidized cracking process, the regenerated catalyst comprising a carbon content of about 0.005% to about 0.30% by weight, based on the total catalyst inventory, and a pentasil containing catalyst/additive composition comprising pentasil zeolite;
about 0.7 to about 4.0% by weight iron oxide; and
about 5.0 to about 20% by weight of a phosphorous (measured as P₂O₅).

19. The regenerated catalyst composition of claim 18, wherein the regenerated catalyst composition has an average particle size of about 20 to about 200 microns.

20. The regenerated catalyst composition of claim 18, wherein the iron oxide is present in the pentasil containing catalyst/additive composition from about 0.9 to about 3.0% by weight.

21-31. (canceled)

32. The process of claim 1, wherein the regenerated catalyst composition exhibits a Davison Attrition Index of less than 5.
